(19) United States
(12) Patent Application Publication
(10) Pub. No.: US 2004/0020068 A1
(43) Pub. Date: Feb. 5, 2004

(54) Tape rule housing with a grip

(76) Inventor: Shin-Lin Lee, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/207,909

(22) Filed: Jul. 31, 2002

(51) Int. Cl. G01B 3/10

(52) U.S. Cl. 33/769

(57) ABSTRACT

An improved structure for a tape rule housing is disclosed. The housing is provided with a separately fabricated grip or a grip in one piece with the housing such that the user is able to grasp the grip conveniently and firmly when handling the tape rule instead of holding entire bulky housing unstably. The engagement of separate grip with the housing can be performed in the way of inlaying or sled and channel meshing. Besides, the grip is enclosed with a slip resistant soft cover so as to assure the gripping comfortability and firmness.

### BACKGROUND OF THE INVENTION

1. Field of the Invention

The present invention relates to an improved tape rule housing structure, and more particularly, a type rule housing provided with a grip for the user to grasp the tape rule firmly when pulling out or retrieving the measuring tape.

2. Description of the Prior Art

A tape rule is widely applicable for surveying in civil engineering, building construction, or carpentry. Hence, the convenieney in handling is the most important feature for a tape rule.

A conventional tape rule contains a reel in its housing, and a length of measuring tape is coiled around the reel. When pulling out the tape, the user has to grasp all over the housing with his/her palm so as to keep the tape rule firmly without dropping off. It is experienced that there happens some problems to the user by handling a tape rule in this way. Namely:

1. The user will be uncomfortable to hold a large size tape rule housing with his/her palm.

2. The user's fingers are prone to be scratched by the high speed retrieving tape.

3. If a tape rule is equipped with a speed controller, it often becomes a cause of trapping fingers

In order to palliate the shortcomings inherent to the conventional technique described above, the present inventor has delved into this matter with long time efforts and has come to realization of the present invention.

### SUMMARY OF THE INVENTION

It is an object of the present invention to provide an ingeniously designed grip for a tape rule housing serving the user to conveniently handling the tape rule without the danger of scratching his/her fingers by the tape or trapping his/her fingers by the speed controller equipped on the housing.

It is another object of the present invention to provide an ingeniously designed grip for a tape rule housing that makes the tape rule easy to handle, and also is simply structured with minimized production cost.

For achieving the above mentioned object, the tape rule housing of the present invention is provided with a grip which can be grasped firmly by the user's hand when handling the tape rule.

In the present invention, the inner cavity of the grip is formed into a recessed portion so as to facilitate the user's fingers to grasp.

In the present invention, the grip can be enclosed with a slip resisting soft fitting so as to facilitate the user to grasp the grip comfortably and firmly without the fear of slipping.

In the present invention, the grip and the housing can be fabricated in one piece.

In the present invention, the grip can be engaged with the housing by inlaying protuberances into corresponding containment holes, wherein the protuberances and containment holes may be formed on either housing side or grip side.

In the present invention, engagement of the grip with the housing may be performed in the way of meshing a sled in a channel, wherein the sled and the channel may be formed on either housing side or grip side.

### BRIEF DESCRIPTION OF THE DRAWINGS

The above objects and other advantages of the present invention will become more apparent by describing in detail the preferred embodiments of the present invention with reference to the attached drawings in which:

FIG. 1 is an exploded illustrative view of the tape rule housing with a grip according to the present invention;

FIG. 2 is the assembled view of FIG. 1;

FIGS. 3A and 3B are the illustrative views of another embodiment according to the present invention; and

FIGS. 4A and 4B are the illustrative view of one more embodiment according to the present invention.

### DETAILED DESCRIPTION OF THE PREFERRED EMBODIMENT

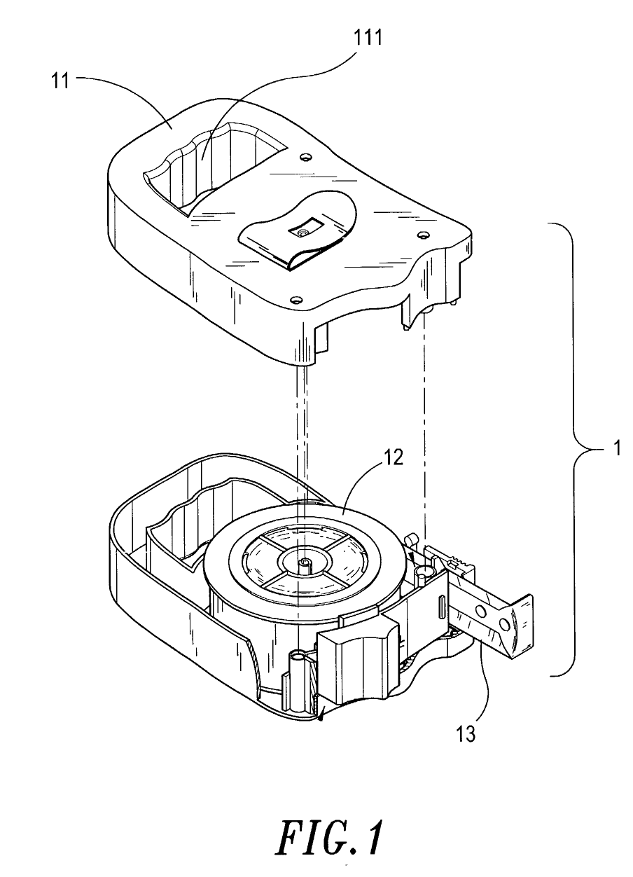

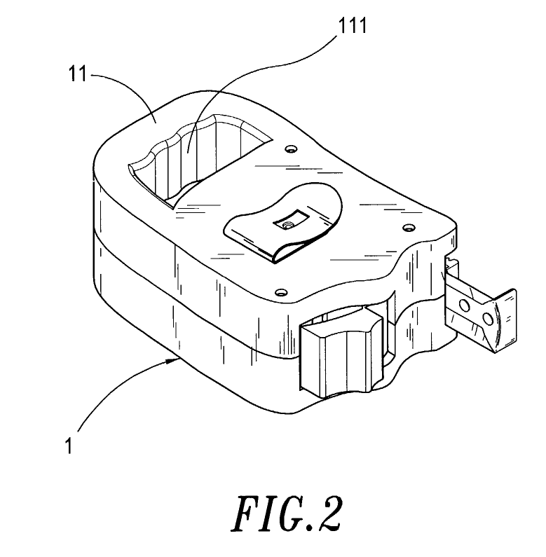

Referring to FIGS. 1 and 2 simultaneously, wherein a grip 11 with a recessed portion 111 is fabricated in one piece with a tape rule housing 1. A reel 12 is accommodated in the inner cavity of housing 1 and a measuring tape 13 is coiled around the reel 12. At the front bottom portion of the housing 1 there is provided a tape exit. The recessed portion 111 of the grip 11 provides the user means for controlling the housing 1 firmly by grasping the grip 11 instead of holding unstably the whole housing 1 for performing surveying work. Furthermore, the grip 11 can be enclosed with a slip resisting soft material so as to assure the gripping comfortability and firmness for the user.

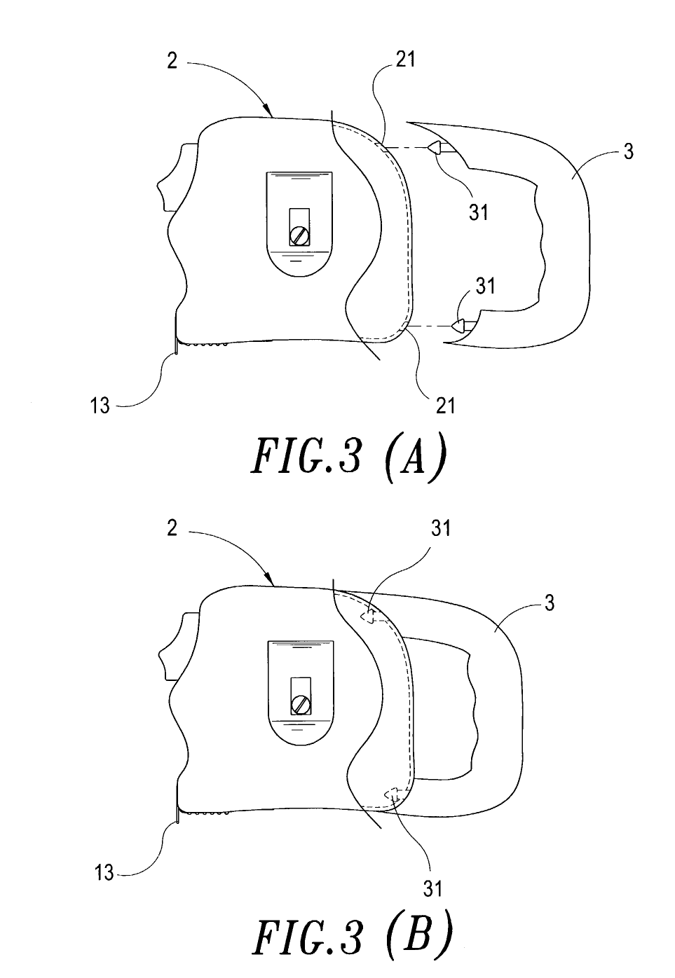

Referring to FIGS. 3A and 3B, in these two drawings which show another embodiment of the present invention, a grip 3 is mated with a housing 2 with a plurality of protuberances 31 formed along its front surface thereof by inlaying into corresponding containment holes 21 formed along rear surface of the housing 2 thereof so as to engage the grip 3 tightly with the housing 2. Meanwhile, the protuberances 31 may be alternatively formed on the housing 2 and the containment holes 21 on the grip 3 without affecting the desired function.

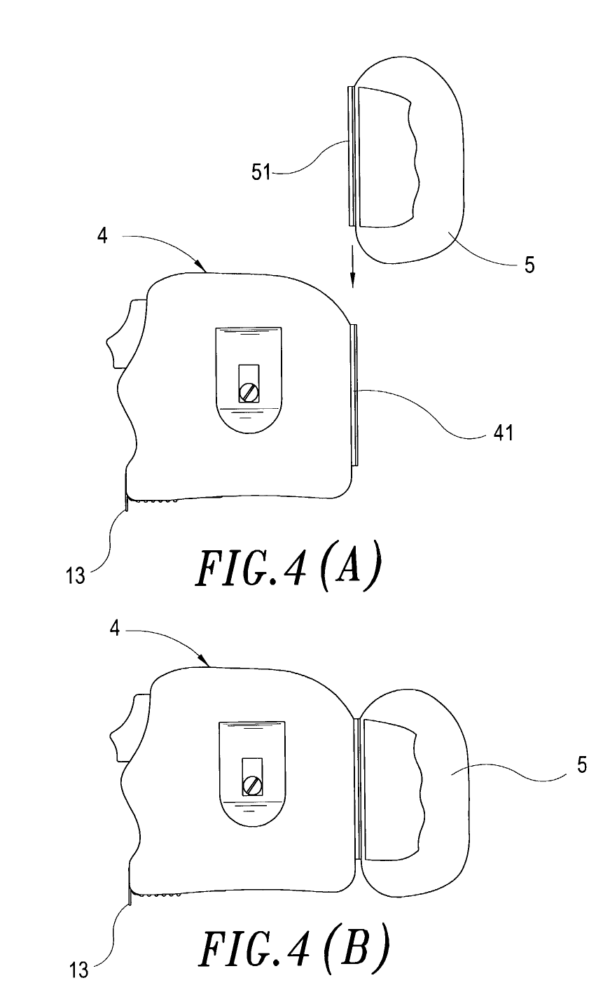

Referring to FIGS. 4A and 4B, in theses two drawings which show one more embodiment of the present invention, a grip 5 is mated with a housing 4 using a sled 51 provided on its front surface thereof in mesh with a channel 41 provided on the rear surface of the housing 4 so as to engage the grip 5 tightly with the housing 4. Meanwhile, the sled 51 may be alternatively provided on the housing 4 and the channel 41 provided on the grip 5 without affecting the desired function.

It is understood from the above description that the tape rule housing of the present invention has several noteworthy advantages:

1. The extra handy grip provided at the rear side of the housing releases the user's inconveniency to hold the whole bulky housing so that there will be no worry of dropping the tape rule.

2. No danger of scratching the user's fingers with the tape edge or trapping the user's fingers with the speed controller.

3. The tape rule with such a simple structure is easy to handle and is able to be fabricated with a low cost.

Those who are skilled in the art will readily perceive how to modify the invention. Therefore, the appended claims are to be construed to cover all equivalent structures which fall within the true scope and spirit of the invention.

What is claimed is

1. A tape rule housing comprising:
a grip attached to its rear surface for the user to grasp.

2. The tape rule housing of claim 1, wherein said grip has a recessed portion in the inner cavity thereof so as to facilitate the user's fingers to grasp at.

3. The tape rule housing of claim 1, wherein said grip is enclosed with a slip resisting soft cover so as to assure the gripping comfortability and firmness for the user.

4. The tape rule housing of claim 1, wherein said grip is fabricated in one piece with said housing.

5. The tape rule housing of claim 1, wherein said grip is engaged with said housing by inlaying.

6. The tape rule housing of claim 1 wherein said grip is engage with said housing by sled and channel meshing.

7. The tape rule housing of claim 5, wherein several containment holes are formed along the rear surface of said housing to accept inlaying corresponding protuberances formed along the front surface of said grip so as to engage said grip with said housing tightly.

8. The tape rule housing of claim 7, wherein said containment holes are formed along the front surface of said grip and the corresponding protuberances are formed along the rear surface of said housing alternatively.

9. The tape rule housing of claim 6, wherein a channel is provided on the rear surface of said housing, while a sled is provided on the front surface of said grip to be in mesh with said channel so as to engage said grip with said housing tightly.

10. The tape rule housing of claim 9, wherein said channel is provided on the front surface of said grip, while said sled is provided on the rear surface of said housing alternatively.
